(19) United States
(12) Patent Application Publication
(10) Pub. No.: US 2022/0253717 A1
(43) Pub. Date: Aug. 11, 2022

(54) SYSTEM AND METHOD FOR BRINGING INANIMATE CHARACTERS TO LIFE

(71) Applicant: Emily Leilani Martin, New York, NY (US)

(72) Inventor: Emily Leilani Martin, New York, NY (US)

(21) Appl. No.: 17/650,176

(22) Filed: Feb. 7, 2022

Related U.S. Application Data
(60) Provisional application No. 63/199,973, filed on Feb. 5, 2021.

(51) Int. Cl. G06N 3/10; G06N 5/00; H04L 51/02

(52) U.S. Cl. CPC G06N 3/10; H04L 51/02; G06N 5/003

(57) ABSTRACT

A method and system for bringing inanimate characters to life as an interactive chatbot. The method transforms a static character to a dynamic chatbot through bringing to life to the character, letting the character evolve, learn, and grow, and thereby be able to engage with, and by extension, cull from human users via a text user interface.

### CROSS-REFERENCE TO RELATED APPLICATION

This application claims the benefit of priority of U.S. provisional application No. 63/199,973, U.S. provisional application number filed 5 Feb. 2021, the contents of which are herein incorporated by reference.

### BACKGROUND OF THE INVENTION

The present invention relates to the field of conversational artificial intelligence and, more particularly, a method and system for bringing inanimate characters to life as an interactive chatbot.

A chatbot or chat bot is a computer program that interacts with another form of intelligence, typically a human user but not exclusively. The interaction is typically conducted over a text interface, perhaps with a static, avatar images in the margin of the text interface. Typically, the chatbot is presented on behalf of an entity, usually over the entity's website or mobile application, to interact with a website or mobile application user to extract information from said user that the entity desires, or to provide entertainment and education to the user. Thus, the entity wants the chatbot to be as engaging as possible to as many different types of individuals as possible.

The effectiveness of the chatbot to retrieve the desired information from a user is, on some level, a function of how engaged that human user is with the chatbot. And it has been said that engagement of a human being with another person or animated object/being/character is based on many key factors, such as a feeling of commonality, relatability, familiarity, etc. (or “social characteristics”) on the part of the human being.

Thus, the social characteristics of the chatbot are critical to the chatbot's effectiveness in terms of how those social characteristics inform the interaction and how they are used to define the resulting chatbot representation on the user interface. Social characteristics expressed through words are, however, static, limiting the sociality or “personality” of the character—i.e., the character does not live beyond the words that are associated with it.

On the other hand, well-known characters that are story-based—whether the story arises from a movie, book, or poem—‘live’ as a result possess a more engaging personality. By well-known characters, it is understood that this character has an inherently understood personality that is or embodies a collectively shared idea, a pattern of thought, or image, etc., such as the Marvel® character Hulk™.

As can be seen, there is a need for a method and system for bringing inanimate characters to life as an interactive chatbot. Thereby transforming an otherwise static character into a dynamic chatbot enabled to live beyond the story and the history that created it, and most importantly be more engaging when interacting with human users, which in turn elicits and evokes information from the human user they would have otherwise withheld from a static character who is defined only by the words they generate over the chatbot interface.

The transformation of a static character to a dynamic chatbot is a novel and non-obvious inherently-computer based process that brings life to the chatbot character, letting the chatbot character evolve, learn, and grow, and thereby be able to engage with, and by extension, cull information from human users via a text user interface.

### SUMMARY OF THE INVENTION

In one aspect of the present invention, a method of responding to chatbot interface input, the method includes forming a decision as to one of a plurality of conversational responses carried by a decision tree in response to the sum of weight coefficients with respective intents of the chatbot interface input; and periodically updating the values of said weight coefficients as a function of a backstory data and background information, wherein the backstory data is associated with a character understood by an inputter of the chatbot interface input.

In another aspect of the present invention, the method further includes wherein the background information is mutually exclusive of the backstory data, wherein the background information is entered by an administrative user, wherein the background information further comprises user profile data, wherein a neural network adjusts the values of said weight coefficients as a function of earlier chatbot interface input, wherein a neural network adjusts the values of said weight coefficients as a function of one or more corrections entered by the administrative user, wherein the backstory data comprises language, tone and events used by said character, and wherein each weight coefficient is a function of at least one of the language, the tone, and the events, wherein an artificial intelligence periodically updates the values of said weight coefficients.

In yet another aspect of the present invention, a system for facilitating the above method of responding to chatbot interface input, the system including a processor, and a memory comprising computing device-executable instructions that, when executed by the processor, cause the processor to implement: a character foundation module for receiving the backstory data; a character-building module for extracting the language, the tone, and the events from the backstory, wherein the character-building module receives the background information from the administrative user, wherein the character-building module established the neural network, and wherein the character-building module uses the artificial intelligence; and a character interaction module for growing the plurality of conversational responses as a function of respective chatbot interface inputs.

These and other features, aspects and advantages of the present invention will become better understood with reference to the following drawings, description, and claims.

### BRIEF DESCRIPTION OF THE DRAWINGS

FIG. 1 is a schematic view of an exemplary embodiment of the present invention.

FIG. 2 is a diagrammatical view of an exemplary embodiment of the present invention.

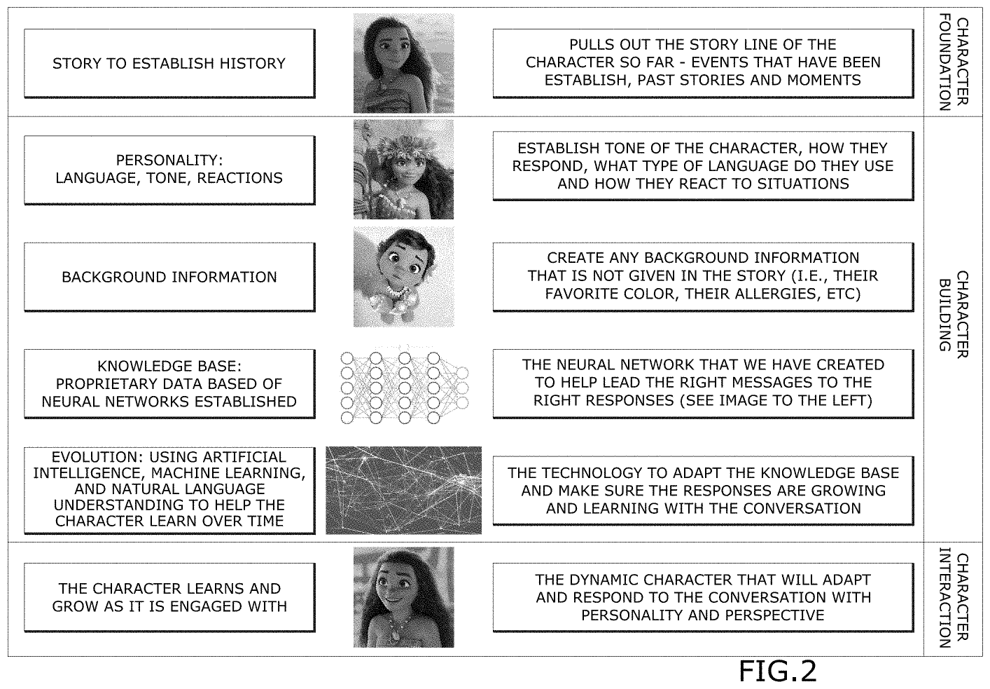

FIG. 3 is a high-level block diagram of an exemplary computing system.

FIG. 4 is a block diagram of an exemplary computer system for use with implementations described herein.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

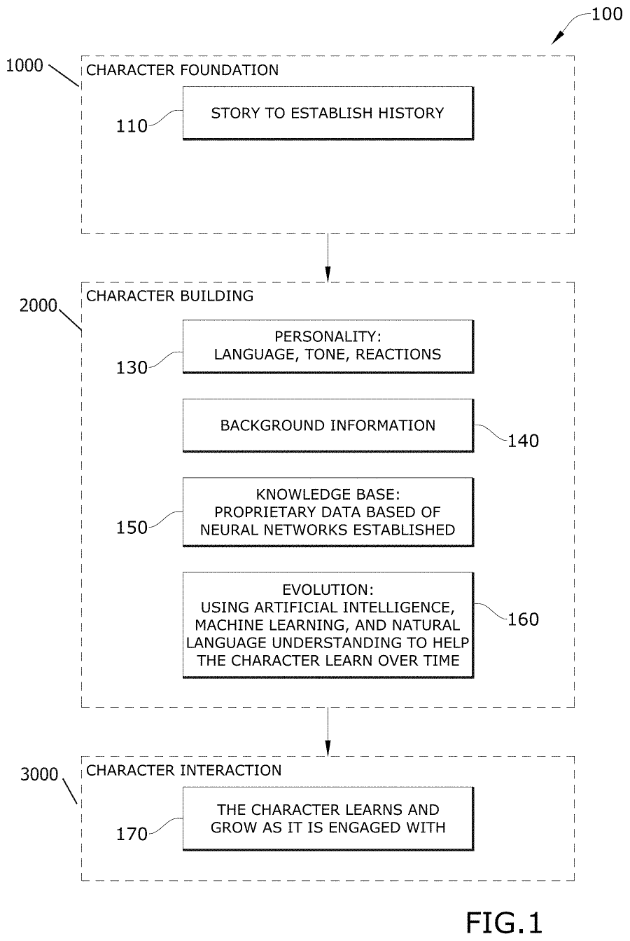

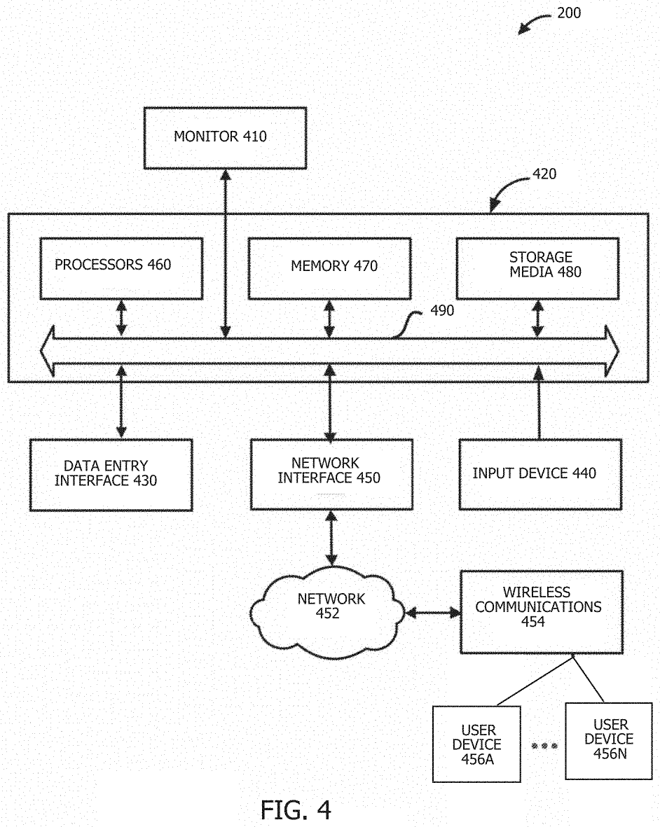

Referring now to FIGS. 1 and 4, the present invention may include a method and system 100 for bringing inanimate characters to life as an interactive chatbot. Alternatively, the method embodied in the present invention discloses a process of transforming a static character into a dynamic, personalized chatbot that is more likely to be engaging to human users and thus more likely to retrieve relevant information via the text interface operatively associated with the dynamic chatbot.

The terms “chat bot, “bot” and/or “bots” as used in this disclosure refer to any system or unit designed and operated to replace, mimic, or simulate a human, such that a user conversing with the inanimate character as if he or she would convers with a human and not a with machine. For example, embodiments of the invention may be applicable to, used with, or embedded in, intelligent personal assistants, virtual agent, automated chat or interactive voice response (IVR) systems or any voice control system or virtual reality or augmented reality. The bot may converse with the user via speech and/or in writing.

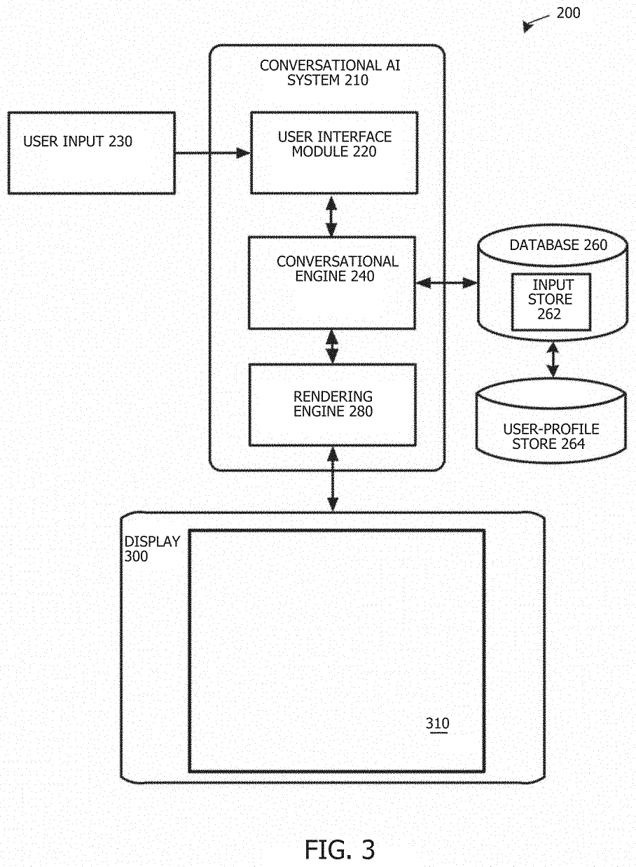

FIG. 3 is a high-level block diagram of an exemplary computing system 100 for implementing chatbot/conversational AI sessions. Computing system 100 may be any computing system, such as an enterprise computing environment, client-server system, and the like. Computing system 100 includes conversational AI system 210 configured to process data received from a user interface 220, such as a keyboard, mouse, etc., regarding processes such as chatting, texting, generating, configuring, modeling, labeling, data binding, maintenance, etc., associated with data elements, information, and the like as described herein.

Note that the computing system 200 presents a particular example implementation, where computer code for implementing embodiments may be implemented, at least in part, on a server. However, embodiments are not limited thereto. For example, a client-side software application may implement the conversational AI system 210, or portions thereof, in accordance with the present teachings without requiring communications between the client-side software application and a server.

In one exemplary implementation, conversational AI system 210 may be connected to display 300 configured to display data 310, for example, to a user thereof. Display 300 may be a passive or an active display, adapted to allow a user to view and interact with graphical data 310 displayed thereon, via user interface (UI). In other configurations, display 130 may be a touch screen display responsive to touches, gestures, swipes, and the like for use in interacting with and manipulating data 310 by a user thereof to communicate user input.

In some implementations, computing system 200 may include a data source such as database 260. The database 260 may include one or more user-profile stores 264 for storing user profiles. The present invention contemplates an input store 262 for retrievably storing user information in the database. The user information may include data gathered through a conversational interface (via the UI) by the user, through registration information provided by the user when registering with the underlying application or entity hosting the chatbot, through online research on the part of underlying application, wherein the user information may include but is not limited to work experience, group memberships, hobbies, educational history, etc.

Database 260 may be connected to the conversational AI system 210 directly or indirectly, for example via a network connection, and may be implemented as a non-transitory data structure stored on a local memory device, such as a hard drive, Solid State Drive (SSD), flash memory, and the like, or may be stored as a part of a Cloud network, as further described herein.

Database 260 may contain data sets, data elements, and information such as metadata, labels, development-time information, run-time information, user configuration information, API, interface component information, library information, error threshold data, pointers, and the like.

Conversational AI system 210 may include user interface module 220, conversational engine 240, and rendering engine 280. User interface module 220 may be configured to receive and process data signals and information received from user interface module 220. For example, user interface module 220 may be adapted to receive and process data from user input associated with data for processing via the conversational AI system 210.

In exemplary implementations, conversational engine 240 may be adapted to receive data from data sources such as user interface module 220 and/or database 260 for processing thereof. In one configuration, 240 may be adapted to receive data from data sources such as user interface module 220 and/or database 260 for processing thereof. In one configuration, is a software engine configured to receive and process input data, such as chat, text, video, output schema parameters, etc., from a user thereof pertaining to data from user interface module 240 and/or database 260 in order to generate a conversational AI session, and then validate and configure the conversational AI session relative to, for example, a type of conversational AI session, processing efficiency, and error thresholds. For example, during a validation process, the conversational engine 240 may analyze data objects in the conversational AI session along with input parameters, processor efficiency thresholds, conversational AI session types, etc. in order to verify and configure decision tree(s) to and/or contextual process to employ during the conversational AI session.

In some implementations, the computing system 200 may be part of a Cloud network as further illustrated on FIG. 4. Computer system 200 is merely illustrative and not intended to limit the scope of the claims. One of ordinary skill in the art would recognize other variations, modifications, and alternatives. For example, computer system 400 may be implemented in a distributed client-server configuration having one or more client devices in communication with one or more server systems.

In one exemplary implementation, computer system 200 includes a display device such as a monitor 410, computer 420, a data entry device 430 such as a keyboard, touch device, and the like, a user input device 440, a network communication interface 450, and the like. User input device 440 is typically embodied as a computer mouse, a trackball, a track pad, wireless remote, tablet, touch screen, and the like. Moreover, user input device 440 typically allows a user to select and operate objects, icons, text, characters, and the like that appear, for example, on the monitor 410.

Network interface 440 typically includes an Ethernet card, a modem (telephone, satellite, cable, ISDN), (asynchronous) digital subscriber line (DSL) unit, and the like. Further, network interface 450 may be physically integrated on the motherboard of computer 420, may be a software program, such as soft DSL, or the like.

Computer system 200 may also include software that enables communications over communication network 452 such as the HTTP, TCP/IP, RTP/RTSP, protocols, wireless application protocol (WAP), IEEE 802.11 protocols, and the like. In addition to and/or alternatively, other communications software and transfer protocols may also be used, for example IPX, UDP or the like. Communication network 452 may include a local area network, a wide area network, a wireless network, an Intranet, the Internet, a private network, a public network, a switched network, or any other suitable communication network, such as for example Cloud networks.

Communication network 452 may include many interconnected computer systems and any suitable communication links such as hardwire links, optical links, satellite or other wireless communications links such as BLUETOOTH, WIFI, wave propagation links, or any other suitable mechanisms for communication of information. For example, communication network 452 may communicate to one or more mobile wireless devices 456A-N, such as mobile phones, tablets, and the like, via a base station such as any acceptable wireless communication means 454.

Where applicable, modules or units described herein, may be similar to, or may include components of, the system 100 described herein. For example, modules shown in FIG. 1, may be or may include a controller, memory, and executable code. It is understood that the system 100 may be embodied in a device having the above-mentioned components.

Furthermore, the conversational AI system 100 contemplates a computer network, such as a cloud infrastructure, including a variety of servers, sub-systems, programs, modules, logs, and data stores. In some embodiments, such a cloud infrastructure may include one or more of the following: server machines, databases, virtual private network, API request server, Natural Language Understanding and Dialogue Management Engine. Any cloud infrastructure may also include suitable components such as network interfaces, security mechanisms, load balancers, failover servers, management-and-network-operations consoles, other suitable components, or any suitable combination thereof.

The conversational AI system 100 disclosed herein may be embodied in the systemic components of FIG. 1, including but not limited to a character foundation module 1000, a character-building module 2000, and a character interaction module 3000.

The character foundation module 1000 may provide a story establishment unit 110 configured to receive backstory data for each of a plurality of characters, wherein each character has a known storyline, surrounding critical character-building events, and an identifiable personality (“social characteristics”), such as the aforementioned Hulk™. By way of another example, the backstory data of, say, Napoleon Bonaparte may include movies or novels about Napoleon Bonaparte, wherein the social characteristics associated with the Napoleon Bonaparte character (e.g., decisiveness and bluntness) portrayed in such stories can be determined by the present invention. The present invention, would in turn, infuse the chatbot with the determined social characteristic. These social characteristics may be determined by analysis of the language and tone used by the Napoleon Bonaparte character in the story as well as by the Napoleon Bonaparte character's non-verbal interactions with other characters and events in the story.

The backstory data may be received from any form of computer communication, currently known or later developed. The received backstory data may be in the form of a story about the character. The social characteristics may include data in the form of interactions between two or more characters, wherein language, tone, and reactions described in the story play a central role therein. The backstory data may include events and a timeline of what has happened to the character to be leveraged by subsequent components of the present invention so that a dynamic functioning chatbot with a “story” can be built off of the backstory data.

The character-building module 2000 receives the output of the character foundation 1000, such as the social characteristics and the story timelines/events of the story establishment unit 110 for each character.

The character-building module 2000 may be configured, through a personality unit 130, to analyze the received social characteristics to determine a personality and tone of an associated chatbot; specifically, how such a character-infused chatbot would respond, what type of language they would use, and how they would react to user input. The social characteristics are expressed in the form the chatbot responses (answers and questions) to user input through increasing the valuation of the probability or intent of each branch (wherein the branch is a response) along a systemic decision tree.

The personality unit 130 is extracted from unit 110 by understanding how a dynamic functioning character should and will response to different inputs. Each (otherwise static) chatbot character is configured take on the social characteristics leveraged from the backstory data of unit 110, thereby adding more of a defined personality to the dynamic functioning character, through unit 130. An administrative user of the present invention may thus select a backstory data associated with a desired character (alternatively, through for example a data entry interface 430, the administrative user may pick a character from a list, thereby retrieving that character's backstory data from internal or external sources). Therefore, the administrative user is enabled to add a specific and unique data set of backstory data to a conversational engine 240 configured to implement a conversational AI session. Thereby, the chatbot of that conversational AI session will be imbued with the social characteristics that unit 130 was able to extract from the backstory data of unit 110—forming a dynamic functioning chatbot having an identifiable set of social characteristics—tone, language, and possibly idiomatic expression culled from the backstory data.

The character-building module 2000 may include an executable background information unit 140, knowledge base unit 150, and an evolution unit 160 configured to further transform the dynamic functioning chatbot/character. The dynamic functioning chatbot/character includes background information that is a data source separate and in addition to the backstory data.

The background information unit 140 may include specific data, The specific events are provided by the entity and may supplement the story establishment unit 110 and its backstory data. Some of this specific data is not what is included in the story but essential for a character to have if they have a life, it can come to life in the form or preferences to different situations outside the storyline created. An example of this data would be, but not limited to, their favorite ice cream flavor, their favorite food, their favorite place to go, their preferences on travel, their favorite color, etc. All of this data that isn't established in unit 110, is added and created in unit 140.

The background information may be accessible by the conversational engine 240 when representing the dynamic functioning chatbot/character over the interactive interface, by way of the conversational AI session, thereby the combination of the backstory data and the background information has an additive effect.

The knowledge base unit 150, is a proprietary systemic database associated with a neural network that will teach each of the characters about the topics, that are added by the interactions of the other characters. This means that all the characters are built to have the same knowledge base that might not have come from their background information unit 140 or their story establishment unit 110.

The systemic database 260 may be conceptually represented through decision trees, wherein each probability of intent of each branch coupled to a shared node (or weightiness) is determined recursively; through, the knowledge data base is not mapped or created in a visual sense. This is the foundation of the all the conversations and responses, all the chatbots are built based on the learnings from all other conversations from all other chatbots. This is like the Wikipedia of the dynamic character, i.e., it knows that when a dog dies—it's a sad moment, when you win an award—it's a celebration, it's the underlying data and learnings from the previous conversations that inform this new chatbot.

The evolution unit 160 uses artificial intelligence, Machine Learning (ML) and Artificial Intelligence (AI) technology, along with natural language understanding (NLU) to ensure the chatbot is growing and learning over time, beyond the presets disclosed above, to evaluate the probability of intent at each decision tree node to determine the weightiest branch in response to user input into the chatbot interface. Wherein the personality unit 130 and the evolution unit 160 embody a recursive analytical process which influenced the knowledge base unit 150, in turn possibly altering the weightiness of the branches of an unchanged decision tree. It's important that the knowledge base keeps growing and adapting to know the right response at the right time. Unit 160 is the ability to grow over time and add to the knowledge base, change the response depending on the cultural environment over time, or help the chatbot feel like it's adapting and aging with the users who is interacting with it. It's the ability to scale the knowledge base and create a personalized experience for each user.

The character interaction module 3000 is configured to receive the dynamic character developed through the character-building module 2000, and further configured to learn and grow by way of its engagement with a human user. The engagement with a human user may include access the users' user profile, which may include, for example, biographic information, demographic information, behavioral information, social information, or other types of descriptive information, such as work experience, educational history, hobbies or preferences, interests, affinities, or location. Interest information may include interests related to one or more categories. Categories may be general or specific.

The steps build upon each other in an ordered arrangement to generate output the chatbot interactivity and function. During the process, the user takes a static character and with the addition of the story, the ML/AI algorithm and the tone will output an interactive chatbot.

A method of using the present invention may include the following. The user would chat with the chatbot to experience the character, and so the technology can be leveraged in all categories—whether it's a teacher in the education space, a fictional character in the entertainment space or a historic character from the past. Moreover, all fields can leverage this technology to bring life to a character. The chatbot can be used to create the following: a teacher giving 24/7 help; a fictional character, bringing to life a character; a historic character, provide education; a celebrity, creating fandom conversations; and anything else that is story-based.

As long as the character has some type of story, module 1000, everything else in module 2000 is created and added to end with module 3000 which is a responsive character that is human-like interactions.

In certain embodiments, the system may refer to any interconnecting network capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In particular embodiments the computing systems includes a processor, a memory, a user interface and a communication interface. In particular embodiments the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example, and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments the memory is non-volatile, solid-state memory.

The user interface includes hardware, software, or both providing one or more interfaces for communication and interaction between a person, and the computer systems and artificial reality (AR), virtual reality (VR) a robot, etc.) As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the invention as set forth in the following claims.

What is claimed is:

1. A method of responding to chatbot interface input, the method comprising:
forming a decision as to one of a plurality of conversational responses carried by a decision tree in response to the sum of weight coefficients with respective intents of the chatbot interface input; and
periodically updating the values of said weight coefficients as a function of a backstory data and background information, wherein the backstory data is associated with a character understood by an inputter of the chatbot interface input.

2. The method of claim 1, wherein the background information is mutually exclusive of the backstory data.

3. The method of claim 2, wherein the background information is entered by an administrative user.

4. The method of claim 3, wherein the background information further comprises user profile data.

5. The method of claim 4, wherein a neural network adjusts the values of said weight coefficients as a function of earlier chatbot interface input.

6. The method of claim 5, wherein a neural network adjusts the values of said weight coefficients as a function of one or more corrections entered by the administrative user.

7. The method of claim 6, wherein the backstory data comprises language, tone and events used by said character, and wherein each weight coefficient is a function of at least one of the language, the tone, and the events.

8. The method of claim 7, wherein an artificial intelligence periodically updates the values of said weight coefficients.

9. A system for facilitating the method of responding to chatbot interface input of claim 8, the system comprising:
a processor, and
a memory comprising computing device-executable instructions that, when executed by the processor, cause the processor to implement:
a character foundation module for receiving the backstory data;
a character-building module for extracting the language, the tone, and the events from the backstory, wherein the character-building module receives the background information from the administrative user, wherein the character-building module established the neural network, and wherein the character-building module uses the artificial intelligence; and
a character interaction module for growing the plurality of conversational responses as a function of respective chatbot interface inputs.
